(19) United States
(12) Patent Application Publication
(10) Pub. No.: US 2023/0359991 A1
(43) Pub. Date: Nov. 9, 2023

(54) REPLENISHMENT PLAN CREATION METHOD, REPLENISHMENT PLAN CREATION RECORDING MEDIUM, AND REPLENISHMENT PLAN CREATION SYSTEM

(71) Applicant: AGC Inc., Tokyo (JP)

(72) Inventor: Naoya TANOUE, Tokyo (JP)

(73) Assignee: AGC Inc., Tokyo (JP)

(21) Appl. No.: 18/355,632

(22) Filed: Jul. 20, 2023

Related U.S. Application Data
(63) Continuation of application No. PCT/JP2022/000976, filed on Jan. 13, 2022.

(30) Foreign Application Priority Data
Feb. 2, 2021 (JP) 2021-015281

(51) Int. Cl. G06Q 10/087; G06Q 10/067

(52) U.S. Cl. CPC G06Q 10/087; G06Q 10/067

(57) ABSTRACT

A replenishment plan creation method to be executed by a computer includes:
estimating an expected date of receipt, by using a remaining amount of a consumable stored in a storage container, weather forecast information of areas where one or more suppliers of the consumable are and an area where a supply destination of the consumable is, and an upper limit value of a storage amount of the storage container, the expected date of receipt being a date on which replenishment of the consumable is to be received; and
outputting replenishment plan information including the estimated expected date of receipt.

### CROSS-REFERENCE TO RELATED APPLICATION

The present application is a continuation application of International Application No. PCT/JP2022/000976, filed Jan. 13, 2022, which claims priority to Japanese Pat. Application No. 2021-015281 filed Feb. 2, 2021. The contents of these applications are incorporated herein by reference in their entirety.

### BACKGROUND OF THE INVENTION

### 1. Field of the Invention

The disclosures herein relate to a replenishment plan creation method, a replenishment plan creation recording medium, and a replenishment plan creation system.

### 2. Description of the Related Art

Conventionally, the inventory of consumables to be used in a production factory or the like where goods are produced is constantly managed so as not to run out of stock. Nowadays, one of the known techniques for preventing a consumable from going out of stock is a system that detects a remaining amount of a consumable and creates an order file in accordance with the remaining amount that is detected.

Nowadays, strong emphasis is placed on the importance of giving greater consideration to delivery companies, one example of this being the “Ijoukishouji ni okeru sochi no meyasu” (Provisional translation: Guidelines for Measures to be Taken in the Event of Extreme Weather) that was issued by the Ministry of Land, Infrastructure, Transport and Tourism. Depending on weather conditions, a situation may arise where the replenishment of a consumable must be postponed. In such a case, the consumable cannot get replenished on schedule, resulting instances where the consumable goes out of stock.

The present disclosure has been made in view of the above-described problem and has an object to prevent consumables from going out of stock.

### RELATED-ART DOCUMENTS

### Patent Documents

Patent Document 1: Unexamined Japanese Pat. Application Publication No. 2003-223581

### SUMMARY OF THE INVENTION

According to one aspect of the present disclosure, there is provided a replenishment plan creation method to be executed by a computer, the method including:
estimating an expected date of receipt, by using a remaining amount of a consumable stored in a storage container, weather forecast information of areas where one or more suppliers of the consumable are and an area where a supply destination of the consumable is, and an upper limit value of a storage amount of the storage container, the expected date of receipt being a date on which replenishment of the consumable is to be received; and
outputting replenishment plan information including the estimated expected date of receipt.

### Effects of the Invention

According to one aspect of the present disclosure, consumables can be prevented from going out of stock.

### BRIEF DESCRIPTION OF THE DRAWINGS

FIG. 1 is a diagram illustrating an example of a system configuration of a replenishment plan creation system;

FIG. 2 is a diagram illustrating an example of a hardware configuration of a replenishment plan creation apparatus;

FIG. 3 is a diagram illustrating an example of a remaining amount database;

FIG. 4 illustrates an example of a supplier database;

FIG. 5 is a diagram illustrating functions of the replenishment plan creation apparatus;

FIG. 6 is a first flowchart illustrating a process of the replenishment plan creation apparatus;

FIG. 7 is a diagram illustrating predetermined conditions under which potential dates are excluded;

FIG. 8 is a diagram illustrating an example of an expected receipt and actual records database;

FIG. 9 is a second flowchart illustrating a process of the replenishment plan creation apparatus;

FIG. 10 is a first diagram illustrating an example of a display in a terminal device;

FIG. 11 is a second diagram illustrating an example of a display in the terminal device; and

FIG. 12 is a third diagram illustrating an example of a display in the terminal device.

### DESCRIPTION OF THE PREFERRED EMBODIMENT

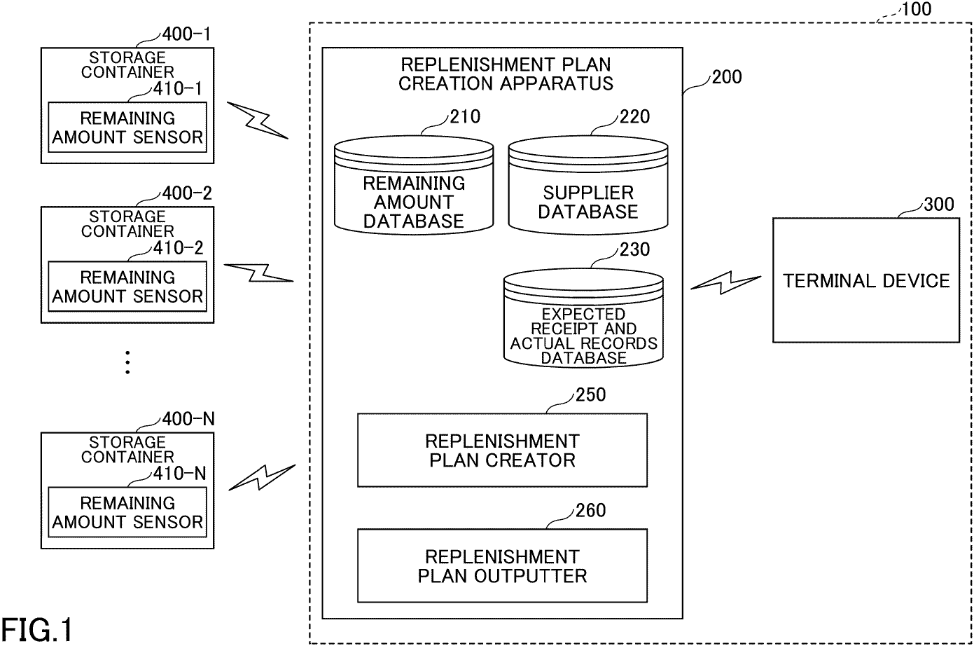

Embodiments are described below with reference to the drawings. FIG. 1 illustrates an example of a system configuration of a replenishment plan creation system.

A replenishment plan creation system 100 includes a replenishment plan creation apparatus 200 and a terminal device 300. The replenishment plan creation apparatus 200 and the terminal device 300 are connected via a network or the like.

Further, the replenishment plan creation system 100 of the present embodiment is implemented, for example, in a production factory or the like that produces goods by using a consumable, and the replenishment plan creation apparatus 200 creates a replenishment plan that includes an expected receipt of replenishment for the consumable and outputs the replenishment plan to the terminal device 300.

The replenishment plan creation apparatus 200 also communicates with various types of server devices present on the network via the Internet or the like.

The terminal device 300 is, for example, a terminal device used by a manager or the like who manages the remaining amount of consumable.

The replenishment plan creation apparatus 200 includes a remaining amount database 210, a supplier database 220, an expected receipt and actual records database 230, a replenishment plan creator 250, and a replenishment plan outputter 260.

The remaining amount database 210 stores therein information, including the remaining amount of consumables of each storage container, collected from a remaining amount sensor installed in consumables storage container installed in a production factory or the like. In the example of FIG. 1, the replenishment plan creation apparatus 200 receives sensor output values (remaining amount of consumables) from remaining amount sensors 410-1, 410-2, ..., and 410-N that are installed in storage containers 400-1, 400-2, ..., and 400-N, and stores the sensor output values in the remaining amount database 210.

Also, the remaining amount database 210 stores therein information indicating the upper limit value and lower limit value of the storage amount of consumables in each storage container and the types of consumables to be stored in the storage container for each storage container 400-1, 400-2, ..., and 400-N.

In the following explanation, in a case where the storage containers 400-1, 400-2, ..., and 400-N are not distinguished from each other, they are referred to as the storage container 400. In addition, in a case where the remaining amount sensors 410-1, 410-2, ..., and 410-N are not distinguished from each other, they are referred to as the remaining amount sensor 410.

In addition, the consumables in the present embodiment may be those used in a glass production process, for example. The storage container 400 in the present embodiment may be, for example, a tank or the like for storing a material to be used in the production of glass. In the following description, a consumable(s) is also referred to as a material(s).

The supplier database 220 stores information regarding suppliers of a material. The expected receipt and actual records database 230 stores replenishment plan information created by the replenishment plan creator 250 and actual records information indicating the actual records of replenishments received in the past. Each database described above is described in detail further below.

The replenishment plan creator 250 refers to the remaining amount database 210 and the supplier database 220 to extract potential dates for the expected date of receipt that is the expected date of receipt for the replenishment of a material. Then, the replenishment plan creator 250 identifies the expected date of receipt from among the potential dates for the expected date of receipt, based on weather conditions on the potential dates for the expected date of receipt, and creates replenishment plan information including both the identified expected date of receipt and information indicating the supplier who is to carry out the replenishment.

The replenishment plan outputter 260 outputs replenishment plan information created by the replenishment plan creator 250. Specifically, the replenishment plan outputter 260 causes the terminal device 300 to display the replenishment plan information.

Thus, in the present embodiment, the potential dates for the expected date of receipt for the replenishment of the material are extracted from the remaining amount data of the storage container 400 and information regarding the suppliers, and the expected date of receipt is identified based on the weather conditions on the potential dates.

Therefore, in the present embodiment, a replenishment plan of the material taking into account the weather conditions when transporting the material from the supplier can be formulated, and thus an occurrence of postponement of the replenishment of the material due to the weather conditions can be prevented. Therefore, according to the present embodiment, the material can be prevented from going out of stock.

In the example of FIG. 1, although the remaining amount database 210, the supplier database 220, and the expected receipt and actual records database 230 are provided in the replenishment plan creation apparatus 200, this is by no means a limitation. Each of the above-mentioned databases may be provided, in part or in whole, in an external device other than the replenishment plan creation apparatus 200. In such a case, the external device and the replenishment plan creation apparatus 200 communicate with each other.

In the example of FIG. 1, although one terminal device 300 included in the replenishment plan creation system 100 is used, the replenishment plan creation system 100 is by no means limited to this. Any number of terminal devices 300 may be included in the replenishment plan creation system 100.

In the example of FIG. 1, although the replenishment plan creator 250 and the replenishment plan outputter 260 are provided in the replenishment plan creation apparatus 200, this is by no means a limitation. Each of the replenishment plan creator 250 and replenishment plan outputter 260 may be implemented by a plurality of information processing devices. In other words, the replenishment plan creation apparatus 200 of the present embodiment may be implemented by a plurality of information processing devices.

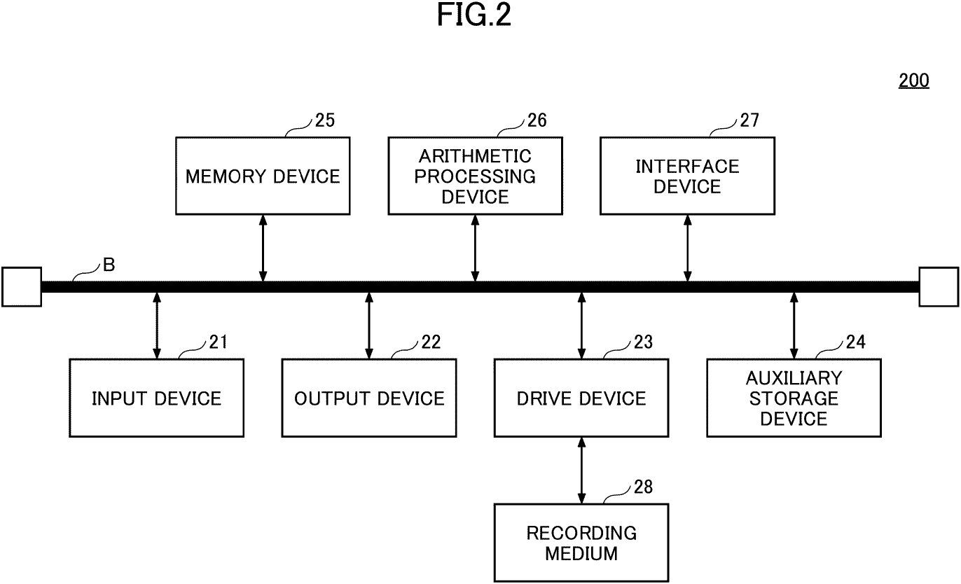

The hardware configuration of the replenishment plan creation apparatus 200 of the present embodiment is described below with reference to FIG. 2. FIG. 2 illustrates an example of the hardware configuration of the replenishment plan creation apparatus.

The replenishment plan creation apparatus 200 of the present embodiment is a computer (information processing device) including an input device 21, an output device 22, a drive device 23, an auxiliary storage device 24, a memory device 25, an arithmetic processing device 26, and an interface device 27 that are interconnected by a bus B.

The input device 21 is a device for inputting various types of information, and is realized by, for example, a touch panel. The output device 22 is for outputting various types of information, and is realized by, for example, a display. The interface device 27 is used to connect to the network.

The replenishment plan output program that implements the replenishment plan creator 250 and the replenishment plan outputter 260 is at least part of the various programs that control the replenishment plan creation apparatus 200. The replenishment plan output program is provided, for example, by distrubtion of a recording medium 28 or by downloading the replenishment plan output program from the network. The recording medium 28 on which the replenishment plan output program is recorded may be any type of recording medium such as a recording medium for optically, electrically, or magnetically recording information, or a semiconductor memory for electrically recording information such as a ROM, flash memory, or the like.

The replenishment plan output program is installed in the auxiliary storage device 24 from the recording medium 28 via the drive device 23 when recording medium 28 including the replenishment plan output program is placed in the drive device 23. The replenishment plan output program downloaded from the network is installed in the auxiliary storage device 24 via the interface device 27.

The auxiliary storage device 24 implementing the remaining amount database 210, the supplier database 220, and the expected receipt and actual records database 230 stores therein the replenishment plan output program installed in the replenishment plan creation apparatus 200, and stores various types of files, data, and so on required by the replenishment plan creation apparatus 200. The memory device 25 reads the replenishment plan output program from the auxiliary storage device 24 and stores therein the replenishment plan output program when the replenishment plan creation apparatus 200 is activated. The arithmetic processing device 26 performs various types of processes as described further below in accordance with the replenishment plan output program stored in the memory device 25.

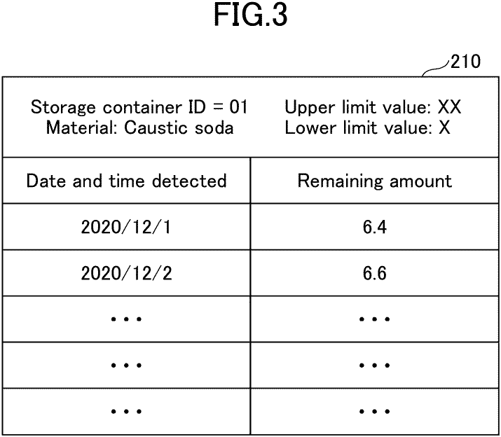

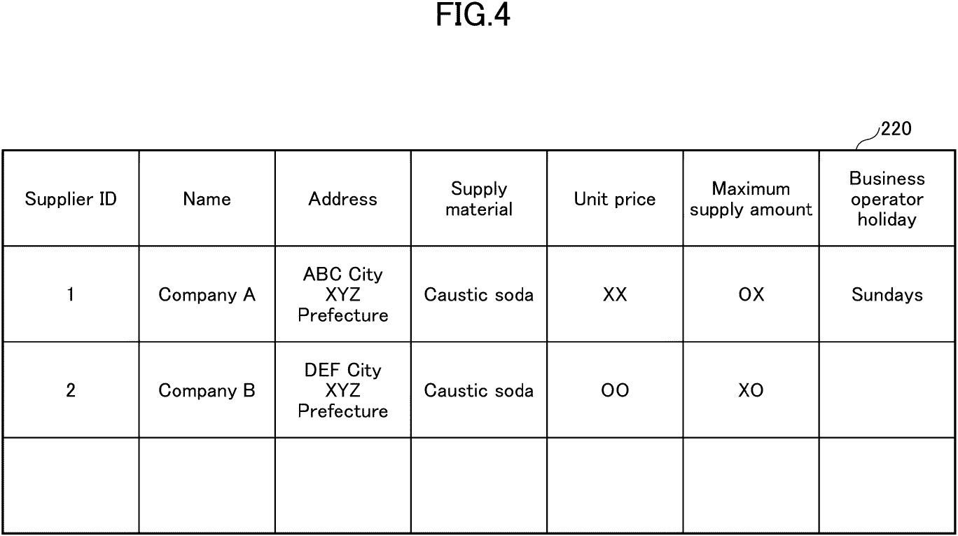

Next, each database included in the replenishment plan creation apparatus 200 of the present embodiment is described with reference to FIGS. 3 and 4.

FIG. 3 illustrates an example of the remaining amount database. The remaining amount database 210 in the present embodiment is provided for each storage container 400. In the example of FIG. 3, the remaining amount database 210 of the storage container 400 specified by the storage container ID “01” that is for identifying the storage container is illustrated.

The remaining amount database 210 of the present embodiment includes, as information items, the storage container ID for identifying the storage container 400, the upper limit value and lower limit value for the storage amount of the material with respect to the storage container 400, the type of material stored in the storage container 400, the remaining amount of material detected by the remaining amount sensor 410 provided in the storage container 400, and the date on which the remaining amount sensor 410 detected the remaining amount.

In the remaining amount database 210, the item “Storage container ID” is associated with other values. In the following description, the information including the value of the item “Storage container ID” and the values of other items in the remaining amount database 210 may be referred to as remaining amount information.

The value of the item “Upper limit value” indicates the maximum amount of material to be stored in the storage container 400. The “Upper limit value” does not necessarily correspond to the maximum amount that can be stored in the storage container 400. For example, the “Upper limit value” is set between 80% and 99% of the maximum amount that can be stored in the storage container 400. In addition, in a case where the material is liquid, this “Upper limit value” is set such that, for example, there is no risk of the liquid splashing and causing overflow while the material is being replenished, or there is no material overflow when the liquid level of the tank fluctuates due to the pressure caused by liquid being pumped from a lorry into the tank while the material is being replenished. The value of the item “Lower limit value” indicates the minimum amount of material that must be stored in the storage container 400.

The information items included in the remaining amount database 210 are only examples and, as such, these are by no means a limitation. The remaining amount database 210 may include items other than those illustrated in FIG. 3.

FIG. 4 is a diagram illustrating an example of the supplier database. The supplier database 220 of the present embodiment may be provided in advance in the replenishment plan creation apparatus 200. The supplier database 220 of the present embodiment includes, as information items, a supplier ID, a name, an address, a supply material, a unit price, a maximum supply amount, business operator holiday, and the like.

In the supplier database 220, the item “Supplier ID” is associated with other items. In the supplier database 220, information including the value of the item “Supplier ID” and the value of other items may be expressed as supplier information.

The value of the item “Supplier ID” is identification information for identifying a business operator or the like to serve as a supplier who supplies materials. The value of the item “Name” indicates the name of the business operator identified by the supplier ID. The value of the item “Address” indicates the address from which the material is to be transported by the business operator identified by the supplier ID.

The value of the item “Supply material” indicates the type of material. The value of the item “Unit price” indicates the unit price of material set by the business operator identified by the supplier ID of the material.

The value of the item “Maximum supply amount” identified by the supplier ID indicates the maximum value of the transportation amount of material that can be transported by the business operator. The maximum amount of material transported is determined, for example, by the amount of material that the supplier can provide and the load on the vehicle transporting the material.

The value of the item “Business operator holiday” indicates that this day is a business holiday of the business operator identified by the supplier ID. In other words, the value of the item “Business operator holiday” indicates the date on which the material is not available from the business operator identified by the supplier ID.

In the example of FIG. 4, the supplier specified by the supplier ID “1” is Company A, is closed for business on Sundays, and the material to be supplied by Company A is caustic soda, which is transported from ABC City XYZ Prefecture to the factory where the replenishment plan creation system 100 has been implemented. In addition, the unit price of caustic soda to be supplied by Company A is “XX” and the maximum supply amount is “OX”.

Further, the supplier database 220 of the present embodiment is provided in advance in the replenishment plan creation apparatus 200, but the value of the item “Unit price” and the value of the item “Maximum supply amount” in the supplier information may be updated.

The expected receipt and actual records database 230 of the present embodiment is updated by a process of the replenishment plan creator 250, and thus details of the expected receipt and actual records database 230 are described further below.

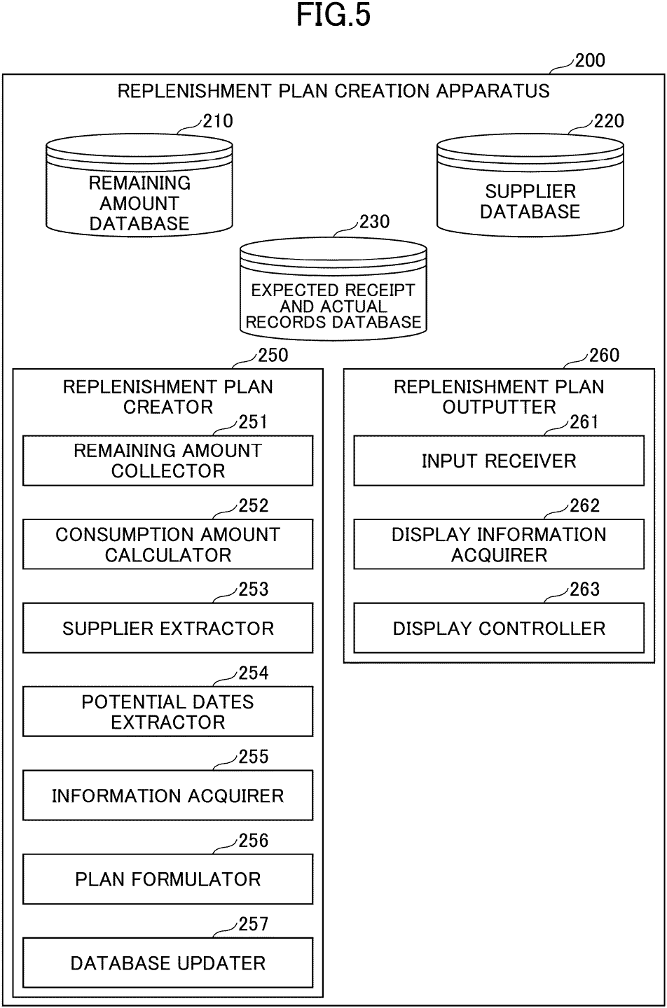

Next, the functions of the replenishment plan creation apparatus 200 of the present embodiment are described with reference to FIG. 5. FIG. 5 is a diagram illustrating the functions of the replenishment plan creation apparatus.

The replenishment plan creation apparatus 200 of the present embodiment includes the replenishment plan creator 250 and the replenishment plan outputter 260. First, the replenishment plan creator 250 is described.

The replenishment plan creator 250 includes a remaining amount collector 251, a consumption amount calculator 252, a supplier extractor 253, a potential dates extractor 254, an information acquirer 255, a plan formulator 256, and a database updater 257.

The remaining amount collector 251 detects the remaining amount of the consumable from the remaining amount sensor 410 of each storage container 400 located on the site of a factory or the like where the replenishment plan creation system 100 has been implemented, and stores the remaining amounts in the remaining amount database 210. As the remaining amount sensor 410, a sensor such as a sensor that detects weight or a level sensor for a case where the material is liquid, particles, or powders can be used.

The consumption amount calculator 252 calculates the consumption amount of the material since the last time the remaining amount collector 251 collected the remaining amount by referring to the remaining amount database 210. The consumption amount calculated by the consumption amount calculator 252 is not limited to this. The consumption amount calculated by the consumption amount calculator 252 may be the consumption amount of the material since the last time the storage container 400 was replenished with the material.

The supplier extractor 253 references the supplier database 220 and extracts supplier candidates in accordance with, for example, the type of material corresponding to the storage container 400.

The potential dates extractor 254 identifies, based on the supplier extracted by the supplier extractor 253, potential dates that can serve as the expected date of receipt for the replenishment of the material.

Specifically, the potential dates extractor 254 may, for example, estimate the manner in which the material inside the storage container 400 will decrease based on both the past material consumption amount stored in the remaining amount database 210 and the current remaining amount of the storage container 400 acquired by the remaining amount collector 251, and then extract, as potential dates, days up to the day prior to when the remaining amount becomes less than the lower limit value.

The conditions for extracting potential dates by the potential dates extractor 254 may be predetermined, for example, by the manager who manages the stock of the materials.

The information acquirer 255 acquires, via the Internet or the like, weather forecast information indicating both the weather forecast in the area where the factory or the like where the replenishment plan creation system 100 is implemented and the areas where the suppliers extracted by the supplier extractor 253 are. In other words, the weather forecast information acquired by the information acquirer 255 is the weather forecast information in the areas where the suppliers of the material (consumable) are and the area where the supply destination of the consumable is. The weather forecast information may be information publicly released by the Japan Meteorological Agency or the like.

In addition, the information acquirer 255 identifies the route leading from the supplier extracted by the supplier extractor 253 to the factory or the like to which the material is to be supplied, and acquires road traffic information regarding the identified route. The identification of the route by the information acquirer 255 may be performed by, for example, a route retrieval service provided or the like via the Internet or the like. In addition, the road traffic information may be publicly available information. In addition, the information acquirer 255 may acquire weather forecast information for an area including the route leading from the supplier to the factory or the like that is the supply destination. By acquiring weather forecast information for an area including the route leading from the supplier to supply destination, a determination, based on weather forecast information, can be made as to whether or not transport can be performed, even in a case where the supplier and the supply destination are far from each other. The weather forecast information acquired by the information acquirer 255 may be information publicly released by the Japan Meteorological Agency or the like.

Hereinafter, the weather forecast information regarding the area where the supplier is, the area where the factory or the like that is the supply destination of the material is, and the area including the route leading from the supplier to the supply destination is also referred to as “weather forecast information of the areas pertaining to transportation”.

The plan formulator 256 creates replenishment plan information based on: the remaining amount of the storage container 400, the upper limit value and lower limit value of the storage container 400, the supplier candidates, the potential dates for the expected date of receipt, weather forecast information, road traffic information, and the like.

Specifically, the plan formulator 256 estimates the expected date of receipt for replenishment of the material, the supplier, and the amount of material to be replenished, and sets the estimated results as replenishment plan information. In other words, the plan formulator 256 creates replenishment plan information including the expected date of receipt for replenishment of material, the supplier, and the amount of materials to be replenished. Details of the process of the plan formulator 256 are described further below.

The database updater 257 updates the expected receipt and actual records database 230 based on the replenishment plan information created by the plan formulator 256. Details of the expected receipt and actual records database 230 and details of updating the expected receipt and actual records database 230 are described further below.

Next, the replenishment plan outputter 260 is described. The replenishment plan outputter 260 of the present embodiment includes an input receiver 261, a display information acquirer 262, and a display controller 263.

The input receiver 261 receives various types of inputs with respect to the replenishment plan creation apparatus 200. Specifically, the input receiver 261 receives inputs such as a display request of replenishment plan information from the terminal device 300.

The display information acquirer 262 acquires information to be displayed in response to a display request. Specifically, the display information acquirer 262 acquires replenishment plan information stored in the expected receipt and actual records database 230, in response to the display request.

The display controller 263 causes the terminal device 300 to display the information acquired by the display information acquirer 262, in response to the display request.

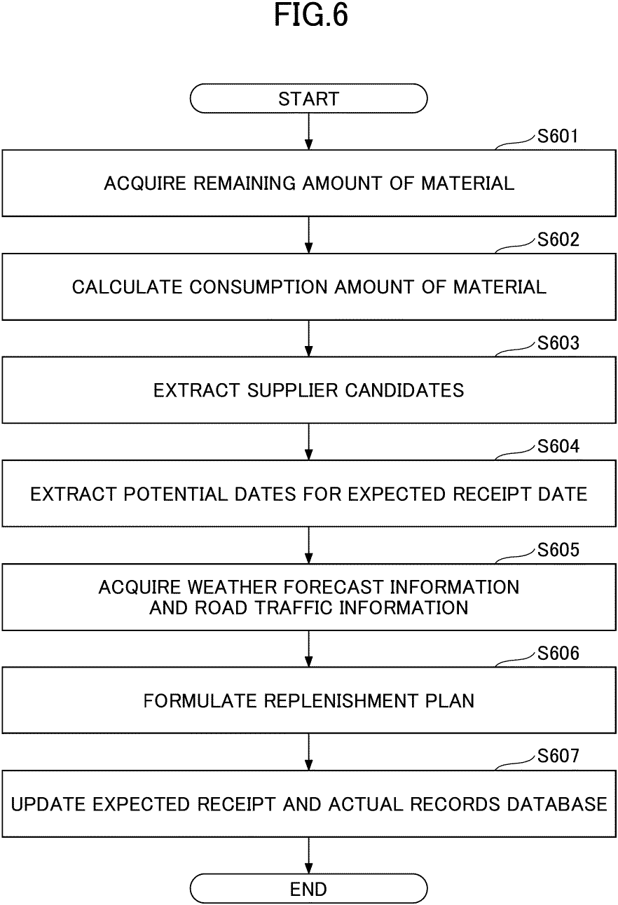

Next, a process of the replenishment plan creation apparatus 200 of the present embodiment is described with reference to FIG. 6. FIG. 6 is a first flowchart illustrating the process of the replenishment plan creation apparatus. FIG. 6 illustrates the creation process of replenishment plan information performed by the replenishment plan creator 250. The process illustrated in FIG. 6 is performed periodically for each storage container 400. Specifically, the replenishment plan creator 250 may execute the process illustrated in FIG. 6 once a day.

The remaining amount collector 251 of the replenishment plan creator 250 acquires a value indicating the remaining amount of material in the storage container 400 based on the remaining amount sensor 410 of the storage container 400 (step S601).

Then, the consumption amount calculator 252 of the replenishment plan creator 250 refers to the remaining amount database 210, compares the value indicating the remaining amount acquired last time with the value indicating the remaining amount acquired in step S601, and calculates the consumption amount of material (step S602).

Then, the by the supplier extractor 253 of the replenishment plan creator 250 extracts the supplier candidate that supplies the material (step S603).

Specifically, the supplier extractor 253 refers to the supplier database 220 and then extracts the suppliers that supply the same type of material as that to be stored in the storage container 400.

Then, the potential dates extractor 254 of the replenishment plan creator 250 extracts the potential dates for the expected date of receipt for the replenishment of the material (step S604).

Then, the information acquirer 255 of the replenishment plan creator 250 acquires both the weather forecast information of the potential dates for the expected date of receipt and the road traffic information (step S605). At this time, the information acquirer 255 may acquire, for example, both the weather forecast information of the areas pertaining to transportation and the road traffic information of suppliers that are the candidates.

Then, the plan formulator 256 of the replenishment plan creator 250 formulates a replenishment plan (step S606). That is, the plan formulator 256 creates replenishment plan information. Details of the process in step S606 are described further below.

Next, the database updater 257 of the replenishment plan creator 250 updates the expected receipt and actual records database 230 based on the replenishment plan information (step S607). After this is performed, replenishment plan creator 250 the terminates the process.

The formulation of the replenishment plan by the plan formulator 256 in step S606 is described below. The plan formulator 256 in the present embodiment, for example, identifies, from among the supplier candidates, a supplier that can supply the same amount of material as the consumption amount calculated in step S602 and has the lowest cost for transporting the material. The cost for transportation is calculated, for example, based on the unit price and maximum supply amount of the material included in the supplier information.

In addition, the plan formulator 256 of the present embodiment may refer to information indicating the business conditions or the like of the suppliers, for example, via the Internet or the like, and identify a supplier from among the supplier candidates in accordance with the referenced results. At this time, the plan formulator 256 may identify multiple suppliers.

In this way, by identifying the suppliers capable of providing the necessary supply amount in accordance with the business conditions and the like of each of the supplier candidates, an occurrence of a situation in which the supply of materials gets interrupted due to poor business performance of any of the suppliers can be substantially prevented.

In addition, by identifying multiple suppliers, supplies can be received, for example, from a second supplier in the event of, for example, a shortage of supplies from the first supplier.

Once the supplier is identified, the plan formulator 256 excludes, from the candidate dates, the days on which the supplier is closed for business, i.e., the closed days. Then, the plan formulator 256 refers to the weather forecast information of the candidate dates excluding those that fall on the closed days of the supplier, and further excludes the candidate dates whose weather conditions indicated by the weather forecast information are the same as the predetermined conditions.

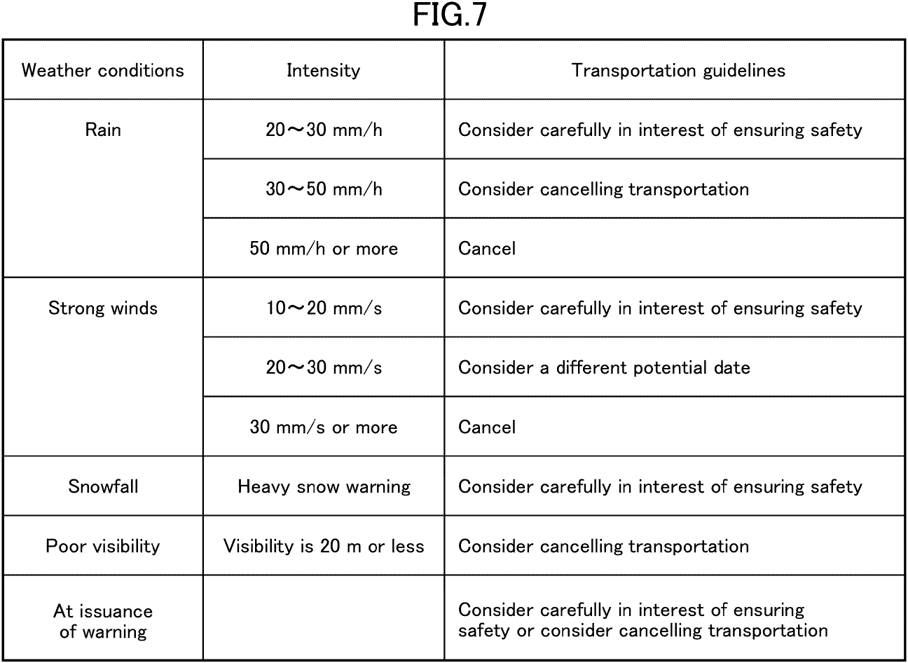

Here, the predetermined conditions under which the candidate dates are described with reference to FIG. 7. FIG. 7 is a diagram illustrating the predetermined conditions under which the candidate dates are excluded.

In the information illustrated in FIG. 7, weather conditions including the items “Weather conditions” and “Intensity” are associated with the transportation guidelines. This information is based on the “Ijoukishouji ni okeru sochi no meyasu” (Provisional translation: Guidelines for Measures to be Taken in the Event of Extreme Weather) that was issued by the Ministry of Land, Infrastructure, Transport and Tourism.

In the present embodiment, for example, weather conditions for which the guidelines for transportation are “Cancel” or “Consider cancelling transportation” in FIG. 7 may be set as the predetermined conditions. Specifically, for example, if the weather condition indicated by the weather forecast information of the areas pertaining to transportation on one of the days among the extracted candidate dates, is “Rain of 50 mm/h or more”, this day would be excluded from the candidate dates.

It should be noted that the predetermined conditions in the present embodiment are based on, but are not limited to, the information based on the “Ijoukishouji ni okeru sochi no meyasu” (Provisional translation: Guidelines for Measures to be Taken in the Event of Extreme Weather). The predetermined conditions may be freely set by the manager or the like who manages the stock of materials.

Furthermore, the present embodiment refers to road traffic information regarding the route leading from the identified supplier to the materials supply destination (transportation destination) such as a factory, and further excludes, from the potential dates, days on which when there are transport difficulties, such as road closures along the route.

Then, the plan formulator 256 sets the potential date(s) remaining that was not excluded from among the potential dates extracted by the potential dates extractor 254 as the expected date of receipt for the replenishment of the material.

In addition, the plan formulator 256 refers to the remaining amount database 210 and calculates the replenishment amount of the material for the expected date of receipt based on the past trend of material consumption or the like.

Then, the plan formulator 256 associates the expected date of receipt estimated by the method described above, the supplier of the material, and the replenishment amount with one another and sets the associated information as the replenishment plan information.

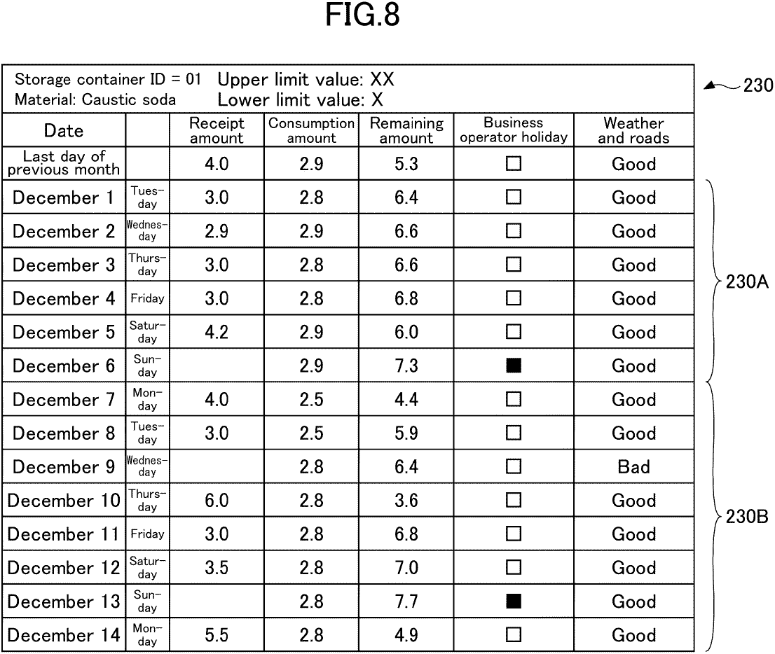

Next, the expected receipt and actual records database 230 of the present embodiment is described with reference to FIG. 8. FIG. 8 illustrates an example of the expected receipt and actual records database.

The expected receipt and actual records database 230 is provided for each storage container 400. In the example of FIG. 8, an expected receipt and actual records database 230 for the storage container 400 identified by the storage container ID “01” is illustrated.

The expected receipt and actual records database 230 includes, as information items, dates, receipt amount, consumption amount, remaining amount, business operator holiday, weather and roads, and the like. In addition, the expected receipt and actual records database 230 includes the storage container ID of the storage container 400 identified by the storage container ID “01”, the type of material, and the upper and lower limit values.

The value of the item “Date” encompasses the date of receipt when materials were replenished in the past and the expected date of receipt estimated by the process of the replenishment plan creator 250.

The value of the item “Receipt amount” indicates the amount of the material replenished. In other words, the value of the item “Receipt amount” is the replenishment amount of the material. The value of the item “Consumption amount” indicates the amount of materials consumed in a single day. The value of the item “Consumption amount” in the present embodiment encompasses the amount of materials consumed in a single day in the past and the estimated consumption amount in a single day in the future.

The value of the item “Remaining amount” indicates the remaining amount of the storage container 400. The value of the item “Remaining amount” encompasses the actual remaining amount detected by the remaining amount sensor 410 and the estimated value of a remaining amount in the future. The value of the item “Business operator holiday” indicates that it is the holiday of the supplier.

The value of the item “Weather and roads” indicates whether the weather conditions and road conditions are suitable conditions for transportation. Specifically, if the value of the item “Weather and roads” is “Good”, this is indication that the weather conditions on the corresponding date do not fall under the predetermined conditions and that the road conditions are not conditions that would interfere with the transportation of materials. That is, if the value of the item “Weather and Roads” is “Bad”, this means that the corresponding date is under a condition enabling the transportation of materials.

If the value of the item “Weather and Roads” is “Bad”, this is indication that the weather conditions of the corresponding date are applicable to the predetermined conditions, or that the road conditions are conditions that interfere with the transportation of materials. That is, if the value of the item “Weather and roads” is “Bad”, this means that corresponding date is under a condition that is not suitable for the transportation of materials. Also, the value of the item “Weather and roads” encompasses both conditions in the past and the estimated results of conditions in the future.

As such, the value of each item expected receipt and actual records database 230 in the present embodiment encompasses both a value indicating past records and estimated values in the future.

In the present embodiment, information in the expected receipt and actual records database 230 in which the value of each item indicates past conditions is called actual records information. Also, in the expected receipt and actual records database 230, information in which the value of each item indicates future conditions is replenishment plan information that is created by the replenishment plan creator 250.

In the expected receipt and actual records database 230 illustrated in FIG. 8, information 230A that is from December 1 to December 6 is actual records information, whereas information 230B from December 7 and beyond is replenishment plan information.

For example, when the replenishment of materials is received according to plan as indicated by the replenishment plan information on December 7, the database updater 257 updates the replenishment plan information on December 7 with the actual records information on December 7 in the expected receipt and actual records database 230 of the present embodiment.

In a case where replenishment different from the plan indicated by the replenishment plan information is performed on December 7, for example, the database updater 257 updates the expected receipt and actual records database 230 with information indicating the details of the replenishment that was actually performed as actual records information on December 7.

In FIG. 8, it can be seen, for example, that the estimated values of the receipt amount (replenishment amount), the consumption amount, and remaining amount have been entered for December 8 and that the December 8 is set as the expected date of receipt of material because the weather conditions and the road conditions on December 8 are estimated to be conditions suitable for the transportation of materials.

In FIG. 8, it can also be seen, for example, that the that the estimated value of the receipt amount (replenishment amount) is not entered for December 9 and that December 9 is not the expected date of receipt of material because weather conditions and the road conditions on December 9 are estimated to be conditions unsuitable for the transportation of materials.

In the replenishment plan creation apparatus 200 of the present embodiment, replenishment plan information is created and the actual records information is updated as described above.

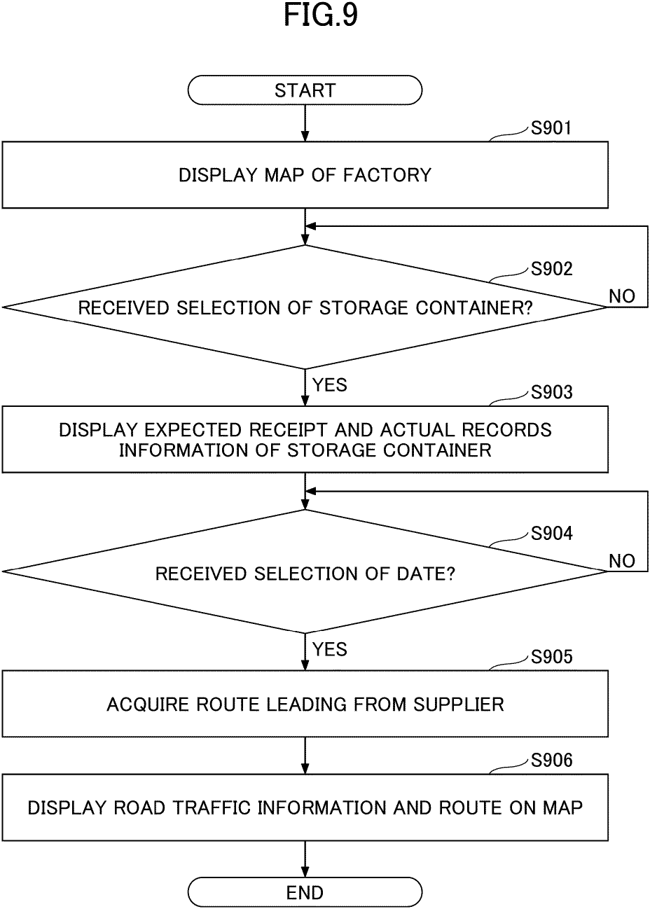

Next, the output of replenishment plan information by the replenishment plan creation apparatus 200 is described. FIG. 9 is a second flowchart illustrating the process of the replenishment plan creation apparatus. FIG. 9 illustrates the process of the replenishment plan outputter 260.

When the input receiver 261 of the replenishment plan outputter 260 of the present embodiment receives a display request for replenishment plan information from the terminal device 300, the display information acquirer 262 of the replenishment plan outputter 260 acquires map information in the factory as display information and displays the acquired map information on the terminal device 300 (step S901).

The map information in the factory may be stored in advance in the replenishment plan creation apparatus 200, or, the map information stored in an external device may be acquired by the display information acquirer 262.

Next, the input receiver 261 of the replenishment plan outputter 260 determines whether or not selection of the storage container 400 is received in the factory map displayed on the terminal device 300 (step S902). If selection is not received in step S902, the replenishment plan outputter 260 stands by until a selection is received. If, at this timing, the replenishment plan outputter 260 receives an instruction from the terminal device 300 to terminate the display process of the replenishment plan information, the replenishment plan outputter 260 may terminate the process.

When the selection is received in step S902, the replenishment plan outputter 260 causes the terminal device 300 to display the actual records information and the replenishment plan information stored in the expected receipt and actual records database 230 corresponding to the selected storage container 400 (step S903). The actual records information and replenishment plan information are acquired from the corresponding expected receipt and actual records database 230 by the display information acquirer 262.

Then, the input receiver 261 of the replenishment plan outputter 260 determines whether or not selection of the date is received in the replenishment plan information displayed on the terminal device 300 (step S904). If the selection of the date is not received in step S904, the replenishment plan outputter 260 stands by until a selection is received. If, at this timing, the replenishment plan outputter 260 receives an instruction from the terminal device 300 to terminate the display process of the replenishment plan information, the replenishment plan outputter 260 may terminate the process.

When the selection of the date is received in step S904, the display information acquirer 262 of the replenishment plan outputter 260 acquires information indicating the route leading from the supplier to the factory that is the supply destination on the selected date (step S905).

Then, the replenishment plan outputter 260 acquires, by the display information acquirer 262, the map information of the area including the supplier and the factory that is the supply destination, and then causes the terminal device 300 to display the map information, the road traffic information of the selected date, and the information indicating the route (step S906). After doing so, the replenishment plan outputter 260 terminates the process.

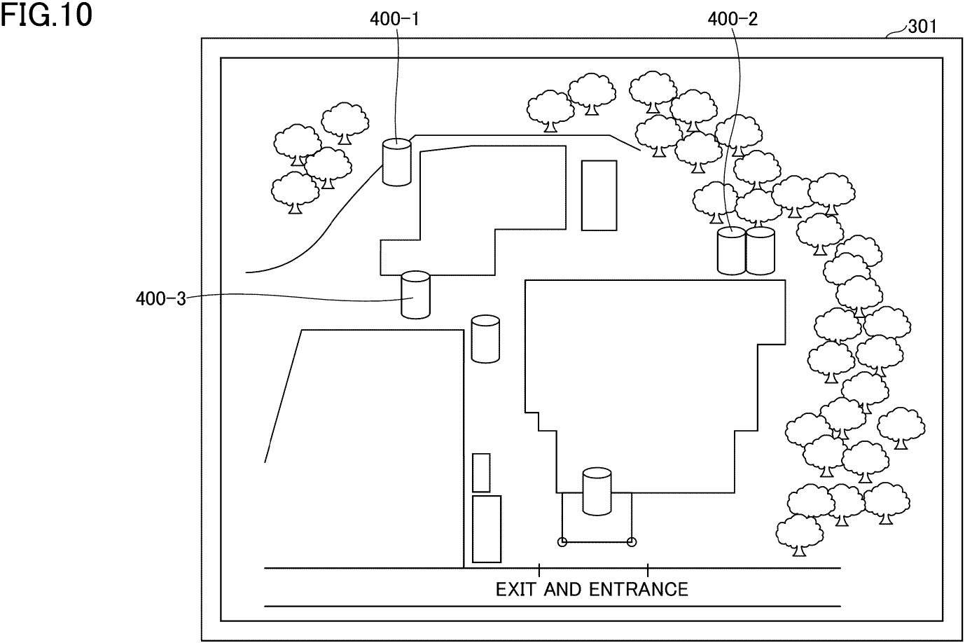

Next, examples of display of the present embodiment are described with reference to FIGS. 10 to 13. FIG. 10 is the first diagram illustrating an examples of a display in the terminal device.

A screen 301 illustrated in FIG. 10 is an example of the screen displayed on the terminal device 300 in step S901 of FIG. 9.

The screen 301 illustrated in FIG. 10 illustrates a map of the site of the factory that is the transportation destination of the materials. The display controller 263 of the present embodiment may display the map such that the storage container 400 located on the site is highlighted on the screen 301. Specifically, for example, the display controller 263 may display an icon image or the like indicating the storage container 400 in a specific color. This display enables the user of the terminal device 300 to easily ascertain the location of the storage container 400.

The storage containers 400-1, 400-2, 400-3, and so on are on the screen 301 and may be highlighted.

For example, when the storage container 400-1 is selected on the screen 301, the display controller 263 of the present embodiment causes the terminal device 300 to display the actual records information and replenishment plan information stored in the expected receipt and actual records database 230 corresponding to the storage container 400-1.

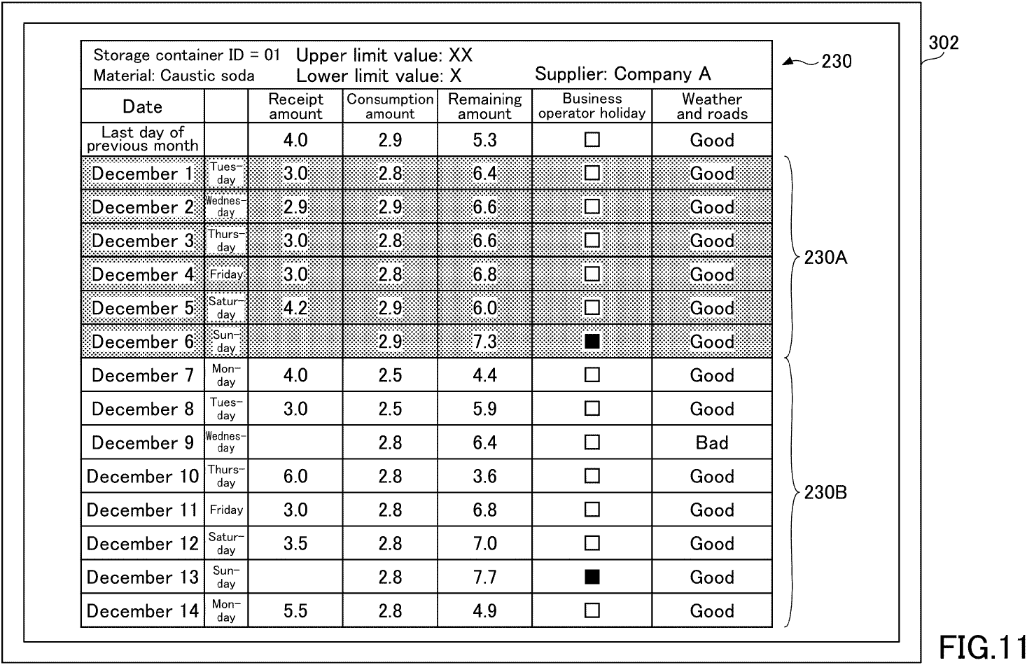

FIG. 11 is a second diagram illustrating an example of a display in the terminal device. A screen 302 illustrated in FIG. 11 is an example of the screen displayed on the terminal device 300 in step S903 of FIG. 9.

When the storage container 400-1 is selected from, for example, the screen 301 of FIG. 10, the display controller 263 transitions the screen 301 to the screen 302.

Here, the storage container 400-1 is the storage container 400 identified by the storage container ID “01”, and the screen 302 displays the actual records information 230A and the replenishment plan information 230B.

In the present embodiment, the manner in which the actual records information 230A and replenishment plan information 230B are displayed may be different.

In the present embodiment, when the storage container 400 is selected from the map of the factory or the like, the actual records information and replenishment plan information corresponding to the selected storage container 400 are displayed. Therefore, the manager who manages the remaining amount of materials in the factory or the like can easily refer to the replenishment plan information for each storage container 400.

In the present embodiment, the expected date of receipt and the information indicating whether the expected date of receipt is a suitable date for transporting materials are displayed as the replenishment plan information. Therefore, according to the present embodiment, there is no need for the manager to check weather forecast conditions, road traffic information, or the like.

When the date (expected date of receipt) of the replenishment plan information 230B is selected from the screen 302, the display controller 263 of the present embodiment causes information indicating the route for transporting the material on this date to be displayed on the screen 302.

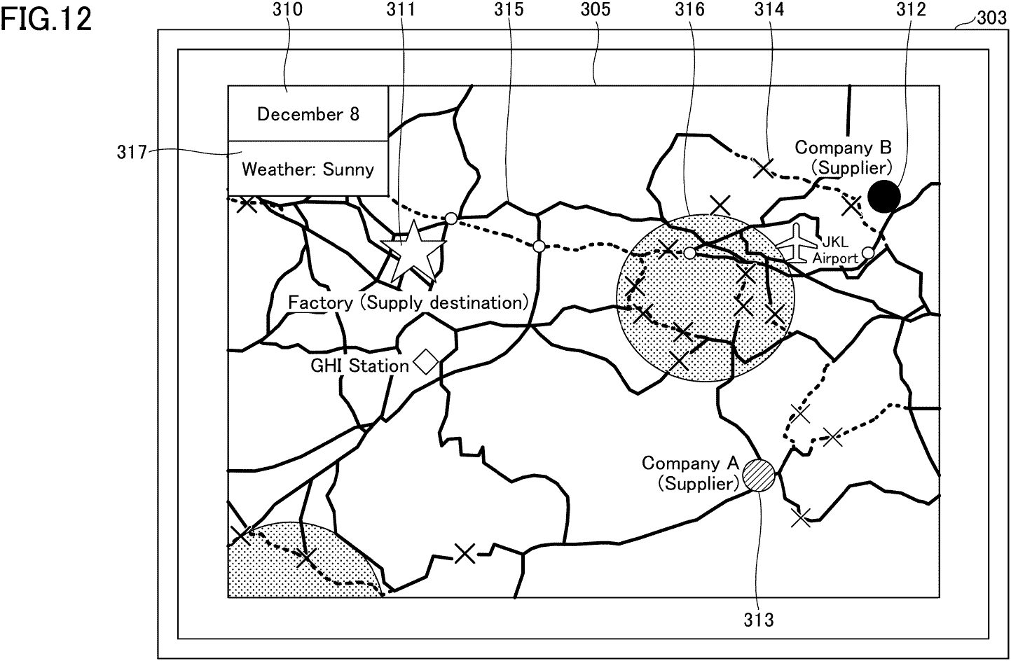

FIG. 12 is a third diagram illustrating an example of a display in the terminal device. The screen 303 illustrated in FIG. 12 illustrates a case where December 8 that is the expected date of receipt is selected in the replenishment plan information 230B displayed on the screen 302. When the expected date of receipt “December 8” is selected on the screen 302, the display controller 263 causes the screen 302 to transition to the screen 303.

On the screen 303, a map 305 of the area including the factory that is the supply destination and the supplier is displayed. Also, on the map 305, information 310 indicating the expected date of receipt, an icon image 311 indicating the factory that is the supply destination (transportation destination) of the material, an icon image 312 indicating Company B that is a supplier, and an icon image 313 indicating Company A that is a supplier are displayed.

The display controller 263 may vary the color of the icon image indicating the supplier according to whether or not the material can be transported. Specifically, for example, the icon image of the supplier from which the material can be transported may be green, and the icon image of the supplier from which the material cannot be transported may be red.

In addition, the display controller 263 displays passable roads differently from the impassable roads in the map 305. In the example of FIG. 12, the passable roads are illustrated by solid lines and the impassable road is illustrated by dotted lines, but the display controller 263 may display the passable road and the impassable road in different colors instead. Specifically, the display controller 263 may display the passable roads in blue, the impassable roads in red, and the impassable areas in red as well, for example.

In the example of FIG. 12, the road or area leading from the Supplier B to the factory illustrated in the icon image 312 includes impassable roads and an impassable area, yet no passable route exists. Therefore, December 8 is unsuitable for transportation from the Supplier B to the factory illustrated by the icon image 312. Thus, the icon image 312 is displayed in red.

In contrast to this, the route leading from the Supplier A to the factory illustrated in the icon image 313 has a passable route, and thus December 8 is suitable for transportation from Supplier A to the factory illustrated in the icon image 313. Therefore, the icon image 313 is displayed in green.

Therefore, the manager who controls the remaining amount of materials in the factory or another facility can readily ascertain that the supplier on December 8 is Company A and that supply from Company B is not available on this date.

In addition, the display controller 263 of the present embodiment may display weather forecast information on the expected date of receipt together with the map 305. In the example of FIG. 12, the weather forecast information 317 is displayed together with the map 305.

By displaying weather forecast information and road conditions obtained based on road traffic information in this way, a manager who manages the remaining amount of materials in the factory or another facility can easily ascertain whether or not transport from each supplier is possible.

Although the screens illustrated in FIG. 10 to FIG. 12 are intended to be displayed on the terminal device 300, this is by no means a limitation. These screens may be displayed on a display or the like connected to the replenishment plan creation apparatus 200, for example.

In the present embodiment, each of the map of the site of the factory, the replenishment plan information, and the map including the suppliers and the factory is displayed on a different screen, but this is by no means a limitation. The map of the site of the factory, the replenishment plan information, and the map including the suppliers and the factory may be displayed in a display region on a single screen, the map of the site of the factory, the replenishment plan information, and the map including the suppliers and the factory being in association with one another.

As described above, in the present embodiment, a value indicating the remaining amount of the storage container 400 is collected from the remaining amount sensor 410, and thus confirmation of the remaining amount is easy. Moreover, in the present embodiment, even if the storage container 400 is small and thus frequent detection of the remaining amount is necessary, management of the remaining amount is easy.

For this reason, even in a case where the same material is stored in multiple storage containers 400 in a factory such as a factory for producing glass or the like, the remaining amount in each storage container 400 can be easily detected, and thus the management of the stock of materials is easy.

Also, in the present embodiment, the replenishment plan information is created by referring to the weather forecast information, and thus the risk of consumables going out of stock can be reduced even when the weather conditions in the future are bad. Also, in the present embodiment, since the consumption amount of the material in the past trends of the consumption amount and remaining amount of the material are observed, the material can be replenished without going out of stock even if the consumption of the material has increased recently.

Furthermore, in the present embodiment, since the expected date of receipt is identified by referring to road traffic information, the materials can be replenished, even if there is a sudden road closure due to road construction or the like, by avoiding such routes, for example.

In addition, the replenishment plan creator 250 of the replenishment plan creation apparatus 200 of the present embodiment creates replenishment plan information by the aforementioned process, but the manner in which the replenishment plan information is created is not limited to this.

The replenishment plan information may be output using a model generated by, for example, machine learning.

In this case, the input data with respect to the model are as follows: the remaining amount that are collected by the remaining amount sensor 410, actual records information, weather forecast information, upper and lower limit values of the storage container 400, and road traffic information. Also, the replenishment plan creation apparatus 200 may generate a model by performing machine learning on the relationship between the input data and the replenishment plan information based on the actual records information stored in the expected receipt and actual records database 230.

Furthermore, as inputs with respect to the model, information indicating the glass composition being produced in the production kiln and information indicating the future glass composition to be produced in this production kiln may be included. When changing the glass composition of glass produced in a particular production kiln, there may be a change in the type of material used. Also, when changing the glass composition, it is necessary to change the type of material or to replace all of the contents of the production kiln, thereby leading to an increase or decrease in the amount of material used.

By including such information in the input data, the material can be prevented from going out of stock even when the amount of material used increases after all of the contents of the production kiln are replaced, for example, in the production of glass.

In addition, if the amount of materials used decreases after all of the contents of the production kiln are replaced, the upper limit value of the storage container might get exceeded and consequently the materials in the storage container may overflow. However, by including such information in the input data, the materials can be controlled so that even if the amount used decreases, the upper limit value of the storage container cannot be exceeded.

The replenishment plan creation method, the replenishment plan creation recording medium, and the replenishment plan creation system, are not limited to the specific embodiments described in the detailed description, and variations and modifications may be made without departing from the spirit and scope of the present invention.

What is claimed is:

1. A replenishment plan creation method to be executed by a computer, the method comprising:
estimating an expected date of receipt, by using a remaining amount of a consumable stored in a storage container, weather forecast information of areas where one or more suppliers of the consumable are and an area where a supply destination of the consumable is, and an upper limit value of a storage amount of the storage container, the expected date of receipt being a date on which replenishment of the consumable is to be received; and
outputting replenishment plan information including the estimated expected date of receipt.

2. The replenishment plan creation method according to claim 1, wherein the computer estimates the expected date of receipt by also referring to road traffic information regarding a road to be used when transporting the consumable.

3. The replenishment plan creation method according to claim 1, wherein the computer estimates the expected date of receipt by also referring to information regarding business conditions of each of the one or more suppliers of the consumable.

4. The replenishment plan creation method according to claim 3, wherein the computer estimates the expected date of receipt by referring to a maximum supply amount of the consumable each of the one or more suppliers is able to supply.

5. The replenishment plan creation method according to claim 4, wherein the computer
identifies, from among the one or more suppliers, a supplier whose cost for replenishing the consumable is lowest by referring to information indicating cost of the consumable of each of the one or more suppliers, the information being stored in a memory, and
estimates the expected date of receipt on which replenishment of the consumable is to be received from the identified supplier.

6. The replenishment plan creation method according to claim 1, wherein the consumable is a consumable to be used in a glass production process.

7. The replenishment plan creation method according to claim 6, wherein the computer estimates the expected date of receipt by further referring to information indicating a glass composition being produced in a production kiln and information indicating a future glass composition to be produced in the production kiln.

8. A non-transitory computer-readable recording medium having stored therein a program that causes a computer to execute a process, the process comprising:
estimating an expected date of receipt, by using a remaining amount of a consumable stored in a storage container, weather forecast information of areas where one or more suppliers of the consumable are and an area where a supply destination of the consumable is, and an upper limit value of a storage amount of the storage container, the expected date of receipt being a date on which replenishment of the consumable is to be received; and
outputting replenishment plan information including the estimated expected date of receipt.

9. A replenishment plan creation system comprising:
a replenishment plan creation apparatus; and
a terminal device,
wherein the replenishment plan creation apparatus includes a memory and a processor configured to:
estimate an expected date of receipt, by using a remaining amount of a consumable stored in a storage container, weather forecast information of areas where one or more suppliers of the consumable are and an area where a supply destination of the consumable is, and an upper limit value of a storage amount of the storage container, the expected date of receipt being a date on which replenishment of the consumable is to be received; and
output replenishment plan information including the estimated expected date of receipt to the terminal device.
